(19) United States
(12) Patent Application Publication
(10) Pub. No.: US 2019/0045310 A1
(43) Pub. Date: Feb. 7, 2019

(54) IN-THE-EAR-HEARING-DEVICE

(71) Applicant: SIVANTOS PTE. LTD., Singapore (SG)

(72) Inventors: DAVID BROSIG, NIEDERWERRN (DE); CHRISTIAN SCHMITT, GROSSENSEEBACH (DE); BENJAMIN SCHMIDT, ROETHENBACH AN DER PEGNITZ (DE); ROLAND WEIGERT, ERLANGEN (DE); ERWIN SINGER, ECKENTAL (DE)

(21) Appl. No.: 16/049,096

(22) Filed: Jul. 30, 2018

(30) Foreign Application Priority Data
Aug. 2, 2017 (DE) 10 2017 213 440.2

(51) Int. Cl. H04R 25/00; H04R 1/22

(52) U.S. Cl. CPC H04R 25/604; H04R 1/222; H04R 1/28; H04R 25/652; H04R 25/48

(57) ABSTRACT

An ITE hearing device or insertion into an auditory canal of a user has a housing formed with an end wall and a side wall which, in the inserted state, is oriented toward an inner wall of the auditory canal. The ITE hearing device further includes at least one microphone arranged in the housing as well as a sound opening arranged at the end wall of the housing for the transmission of sound to the at least one microphone. The sound opening is connected via a sound channel to the at least one microphone. The sound channel is at least partially formed by a lateral recess formed in the side wall of the housing.

The invention relates to an in-the-ear hearing device (ITE hearing device) for insertion into an auditory canal with the features of the preamble to claim 1.

Hearing devices are wearable hearing apparatuses that are in general designed for the output of sound. Sound refers here in general to an acoustic signal, for example music and/or speech.

A hearing apparatus refers here in general to any device producing a sound stimulus that can be worn in or at the ear, for example a headset, headphones and the like. Hearing devices are in particular also designed as hearing aid devices. Hearing aid device refers to a device for supplying a person whose hearing is damaged or impaired, said person wearing the hearing aid device in particular continuously or most of the time in order to compensate for a hearing deficit. In common speech, hearing aid devices are also referred to for short as hearing devices.

In order to satisfy the numerous individual needs, different structural types of hearing devices, such as the behind-the-ear hearing devices (BTE), hearing devices with an external receiver (RIC, receiver-in-canal), in-the-ear hearing devices (ITE), for example also concha hearing devices or canal hearing devices (ITE, CIC), are offered. These examples of hearing devices listed are worn on the outer ear or in the auditory canal. In addition, however, bone conduction hearing aids, implantable or vibrotactile hearing aids, are also available on the market. The stimulation of the damaged hearing faculty is performed here either mechanically or electrically.

An ITE hearing device and a method for the manufacture of such an ITE hearing device may be found in U.S. Pat. No. 6,473,512 B1. The ITE hearing device described comprises in particular an elastic housing in order to improve wearing comfort.

The ITE hearing device further comprises a ventilation duct, as well as a microphone arranged at an end wall (also called the faceplate).

Usually, a housing of a hearing device, in particular of an ITE hearing device, is adapted to an auditory canal of a user. As a result, an interior space, also referred to as the receiving space, for arranging the individual hearing device components such as, for example, a microphone, a signal processing unit and a receiver, is restricted.

On this basis, the invention addresses the object of providing an ITE hearing device with a large receiving space.

The object is achieved according to the invention by an ITE hearing device with the features of claim 1.

Advantageous embodiments, developments and variants are the objects of the dependent claims.

The ITE hearing device, referred to below for short as hearing device, is designed for insertion into an auditory canal of a user. The hearing device comprises a housing that comprises an end wall and a side wall. The side wall in the inserted state is oriented toward an inner wall of the auditory canal of the user. Usually, the side wall of the hearing device is adapted to the auditory canal of the user, in particular in such a way that the side wall lies at least partially against the inner wall of the auditory canal of the user. The housing of the hearing device is preferably adapted in a user-specific manner for this purpose. This means, for example, that in the course of a pre-fitting session at the acoustic technician prior to the manufacture of the hearing device, an impression of the auditory canal of the user is prepared, to which the housing is adapted during manufacture. In this way in particular an appropriate seating of the hearing device is ensured, and thereby a high wearing comfort. In the inserted state, the end wall is oriented toward the front, i.e. runs transverse to the auditory canal. The end wall closes or covers the opening to the auditory canal completely, or at least largely.

The hearing device furthermore comprises at least a microphone for the reception of sound, for example speech and/or music. The microphone is, for example, designed as a sound transducer in a known manner.

The hearing device also comprises a sound opening arranged at an end wall of the housing for the transmission of sound to the at least one microphone. The sound opening is connected via a sound channel to the microphone, wherein the sound channel is at least partially formed by a lateral recess in the side wall of the housing. A wall thickness of the side wall at the location of the sound channel is at least reduced to form the recess, so that the sound channel is integrated into the side wall. The sound channel therefore runs at least partially inside the side wall that is adapted to the auditory canal of the user. Due to the recess, the wall thickness of the side wall in the region of the sound channel from an inner side of the side wall here is in general at least reduced. The sound channel therefore runs along the side wall.

Through the integration of the sound channel into the side wall, an enlargement of an interior space for receiving the individual hearing device components is achieved.

Preferably the microphone comprises a sound inlet that is oriented in the direction toward the recess. Sound inlet refers in this case to a part of the at least one microphone which comprises for example a membrane for receiving the sound. The advantage is that through this an undisturbed reception of the sound that is guided through the sound channel is enabled.

In a preferred embodiment, the microphone is in general positioned to the side next to the sound channel, and bounds the recess to the side. This means that the microphone forms a boundary of the sound channel. In general, microphone refers here to a component that comprises a microphone housing with the sound inlet opening and an internal sound transducer lying within the microphone housing. The sound channel thus extends from the end wall, within the side wall (in the direction of the side wall, and thus in the direction of the auditory canal). The length of the sound channel here preferably corresponds to the length of the microphone that bounds the sound channel against an interior space of the housing.

In order to ensure such an arrangement of the at least one microphone, a holder that is connected to the side wall, and on which the at least one microphone is arranged, is provided according to one expedient embodiment. The microphone is thus arranged laterally in the housing, so that an adequate reception of the incoming sound is ensured.

The recess is preferably open to the end wall, i.e. the recess does not have a boundary at the front face in the region of the side wall. This allows the recess to be fabricated easily.

ii According to one preferred embodiment, as already explained, the wall thickness of the side wall, in particular only at the location of the recess, is reduced to form the recess. In the other regions, the side wall has a greater wall thickness. The sound channel thus runs in particular on the inside of the housing. To form the recess, the wall thickness at the location of the recess is reduced, for example in the manner of a groove, by a third, in particular by a half.

The advantage is that the sound channel can easily be integrated laterally in the side wall of the housing.

Preferably the recess is designed as a wall opening. Wall opening refers here to the fact that at the location of the recess the side wall is entirely removed, so that the sound channel is open laterally to the auditory canal. The lateral recess of the sound channel therefore is not created until in the inserted state by an inner wall of the auditory canal of the user. In this way a saving of material is achieved, and thus an enlargement of the interior space.

To bound the recess, and thus to bound the sound channel, the wall opening is bounded on at least, and preferably only, three sides by a material of the side wall. Preferably, the three sides refers to all the sides of the in particular rectangularly shaped recess with the exception of the side that faces the end wall of the housing. In this variant, the sound channel is therefore formed by an in particular slot-like opening in the side wall that is open upward to the end wall. The at least three sides of the recess therefore only form an approximately Ushaped boundary. At least one, preferably both of the intermediate surfaces covered by this U-shaped boundary is/are open.

According to one expedient development, the recess is bounded toward the outside by a material film. “Toward the outside” here primarily refers to the direction of the inner wall of the auditory canal of the user. Material film refers here in particular to a covering of the recess for example in the manner of a foil, in particular a waterproof foil.

In particular in this way a soiling of the sound channel and/or of the at least one microphone for example by sweat and/or cerumen is prevented.

In general the housing is manufactured for example by (injection) molding. The material film here is an integral, one-piece region of the housing.

Preferably the housing comprises at its end wall a battery flap. The battery flap is arranged on a pivot axis and designed to be pivotable around it. It serves for an accessibility of the battery arranged within the housing, for example in order to exchange it. The sound opening is furthermore integrated into the battery flap. For this purpose the battery flap has, for example, a material projection that comprises, for example, a drilled hole as a sound opening. The material projection covers an inlet of the sound channel. In this way in particular a penetration of, for example, dirt and/or cerumen into the sound channel is prevented. At the same time a “passage” of the sound through the drilled hole is ensured.

In an expedient addition, the battery flap comprises a protective element extending into the recess. Preferably the protective element is arranged at the battery flap angled in the direction of the sound channel. This is used in particular to remove dirt, for example cerumen, that has penetrated into the recess. For this purpose, the protective element is arranged in such a way at the battery flap that when the battery flap is opened the protective element is drawn out of the recess, and thus carries the dirt with it out of the recess.

According to a preferred development, the protective element lies at least partially against wall regions that bound the recess. In particular the protective element lies in a form-fitting manner at the wall regions in the recess. The advantage of this arrangement is that it is thus possible to remove dirt out of the whole recess.

Expediently the protective element is formed as a frame which is in particular inset in a form-fitting manner in the recess. In addition to the advantage already mentioned of the complete removal of dirt out of the whole recess, this embodiment has the further advantage that the protective elements does not cover the sound inlet of the microphone, and thus an unimpaired, unattenuated reception of the sound by the microphone is ensured.

In particular the ITE hearing device described is designed as a canal hearing device, preferably as a Completely-In-The-Canal hearing device (CIC hearing device). In hearing devices of this type, the end wall of the housing is arranged for example inclined with respect to the direction of the auditory canal, as a result of which CIC hearing devices are visually unobtrusive. CIC hearing devices—in the field of the ITE devices—furthermore offer an advantageous compromise in respect of unobtrusiveness, technical facilities and battery service life.

Exemplary embodiments of the invention are explained below in more detail with reference to the figures. These show, in part using highly simplified illustrations:

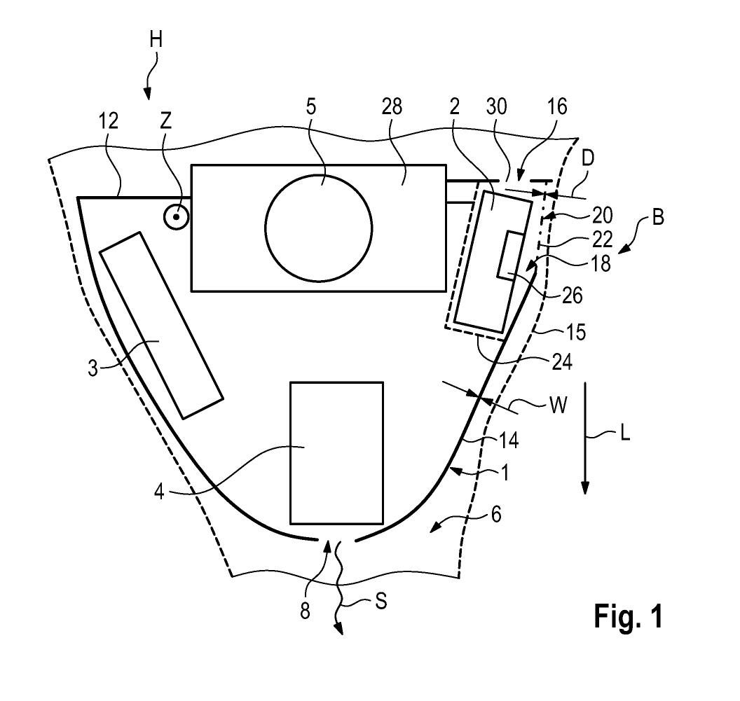

FIG. 1 a sketch of a cross sectional illustration of an inserted ITE hearing device, and

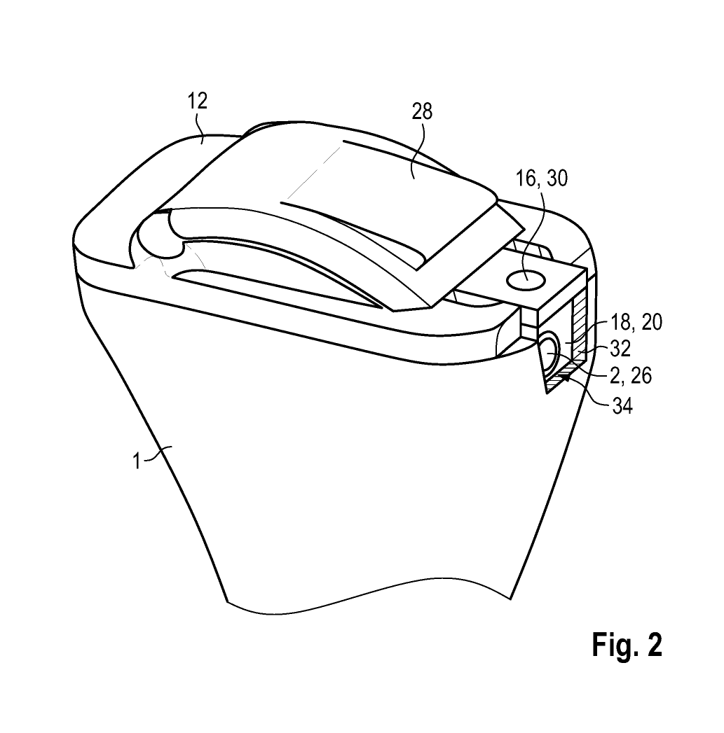

FIG. 2 a perspective illustration of an ITE hearing device with an arranged protective element.

Parts with the same function are shown with the same reference signs in the figures.

A sketch of a cross sectional illustration of an ITE hearing device H is shown in FIG. 1. The ITE hearing device H, referred to below as hearing device H, is designed in the exemplary embodiment as a Completely-In-The-Canal hearing device H (CIC hearing device). The hearing device H is inserted into an auditory canal 6 of a user in a longitudinal direction L. The hearing device H furthermore comprises a housing 1 with an end wall 12 and a side wall 14 adapted to the auditory canal 6 of the user. The side wall 14 in the inserted state is oriented toward an inner wall 15 of the auditory canal 6 of the user. The end wall 12 is oriented transversely with respect to the longitudinal direction L, and arranged against the longitudinal direction L at one end of the housing 1. Usually the end wall 12 also comprises operating elements, for example a volume control to regulate the volume of the amplified signal and/or a selection knob for selecting various operating modes of the hearing device H.

The hearing device H furthermore comprises hearing device-specific components, such as for example a microphone 2, a signal processing unit 3, a receiver 4 and a battery 5 for electrical supply of the hearing device H, in particular of the signal processing unit 3. The receiver 4 transmits an acoustic output signal through a housing outlet 8 to the eardrum 10 (not shown in FIG. 2) of the user.

A sound opening 16 for the transmission of sound to the microphone 2 is furthermore arranged at the end wall 12 of the housing 1. The sound opening 16 is connected via a sound channel 18 to the microphone 2. This means that according to the first variant embodiment, the sound channel 18 is integrated into the side wall 14. The side wall 14 has a lateral recess 20 for this purpose. In other words: a wall thickness W of the side wall 14 is reduced according to a first variant embodiment in a region B to form the recess 20. The region B refers in this case to a part of the side wall 14 of the housing 1 that is oriented in the direction of the end wall 12.

Alternatively the region B comprises a wall opening, through which the sound channel 18 is only formed on the outside by the inner wall 15 of the auditory canal 6 of the user when the hearing device H is in the inserted state. Alternatively or in addition to the last-mentioned variant, the recess comprises a material film 22 which bounds the recess 20 toward the outside toward the inner wall 15 of the auditory canal 6, and thus forms the sound channel 18. Material film 22 in this case refers preferably to a cover having the nature of a foil which has a thickness D which corresponds, for example, to one tenth of the wall thickness W of the side wall.

The material film 22 is, for example, in particular hydrophobic, in order for example to prevent a penetration of liquids, e.g. sweat and/or water, into the microphone 2.

The microphone 2 of the hearing device H is arranged by means of a holder 24 at an inner side of the side wall 14 in such a way that a sound inlet 26 of the microphone 2 is oriented towards the recess 20. An optimum reception of the sound is ensured in this way. The microphone 2 is here preferably designed as a construction unit with a microphone housing and the sound inlet 26, and comprises a sound transducer, not illustrated in more detail here.

The sound channel 18 is thus formed by the lateral recess 20 and by the microphone 2, in particular the sound inlet 26, and by the wall regions 34 of the housing 1 that are surrounded by the recess 20 (cf. FIG. 2). The microphone 2, that is in particular the microphone housing, therefore extends along the recess 20, and closes this off towards the inner side.

The hearing device H furthermore comprises a battery flap 28 that is arranged pivotably around a pivot axis Z at the housing 1, in particular at the end wall 12. The battery flap 28 serves in the exemplary embodiment to hold the battery 5, and in particular can be pivoted out in order to change the battery 5.

The sound opening 16 is in addition integrated into the battery flap 28. For this purpose, in the exemplary embodiment the battery flap 28 has a hole with the nature of a drilled hole 30, through which the sound enters into the sound channel 18.

A perspective view of an ITE hearing device H when not in the inserted state is shown in FIG. 2. The hearing device H illustrated is in particular identical in construction to the hearing device H described in FIG. 1. It thus comprises all of the components named in FIG. 1, not all of which are visible. The hearing device H additionally comprises an optional protective element 32 at a battery flap 28 angled in the direction of a sound channel 18. The protective element 32 is arranged for this purpose, for example glued, on the battery flap 28. Alternatively, the battery flap 28 and the protective element 32 are manufactured as a onepiece, in particular monolithic, workpiece, for example as an injection molded part.

The sound channel 18 is formed when in the inserted state by a recess 20 in the form of a wall opening in a side wall 14 of a housing 1. The protective element 32 in the exemplary embodiment is formed in the manner of a frame, and lies in particular at the wall regions 34 that bound the recess 20. In the exemplary embodiment, the protective element 32 lies in a form-fitting manner at the wall regions 34.

This enables the removal of dirt, for example cerumen, inside the sound channel 18, since when the battery flap 28 is opened the protective element 32 is pulled against the longitudinal direction L out of the sound channel 28, and thus carries accumulated dirt with it.

### LIST OF REFERENCE SIGNS

1 Housing
2 Microphone
3 Signal processing unit
4 Receiver
5 Battery
6 Auditory canal of the user
8 Housing outlet
12 End wall
14 Side wall
15 Inner wall of the auditory canal
16 Sound opening
18 Sound channel
20 Lateral recess
22 Material film
24 Holder
26 Sound inlet
28 Battery flap
30 Drilled hole to form the sound opening
32 Protective element
34 Wall regions
B Region of the side wall
D Thickness of the material film
H Hearing apparatus
S Acoustic signal
L Longitudinal direction W Wall thickness of the side wall
Z Pivot axis

1-14 (canceled)

15. An ITE hearing device for insertion into an auditory canal of a user, the hearing device comprising:
a housing having an end wall and a side wall, wherein said side wall, in an inserted state, is oriented toward an inner wall of the auditory canal;
a microphone disposed in said housing, a sound opening formed at said end wall of said housing for a transmission of sound to said microphone;
a sound channel connecting said sound opening to said microphone, said sound channel being at least partly formed by a lateral recess formed in said side wall of said housing.

16. The ITE hearing device according to claim 15, wherein said microphone is formed with a sound inlet that is oriented toward said recess.

17. The ITE hearing device according to claim 15, wherein said microphone is positioned laterally adjacent said sound channel.

18. The ITE hearing device according to claim 15, which comprises a holder connected to said side wall and holding said microphone.

19. The ITE hearing device according to claim 15, wherein said recess in said side wall is open in a direction toward said end wall.

20. The ITE hearing device according to claim 15, wherein a wall thickness of said side wall is reduced to form said recess.

21. The ITE hearing device according to claim 15, wherein said recess is a wall opening.

22. The ITE hearing device according to claim 15, wherein said recess is bounded on at least three sides by material of said side wall.

23. The ITE hearing device according to claim 15, which comprises a material film outwardly bounding said recess toward said auditory canal.

24. The ITE hearing device according to claim 15, wherein said end wall of said housing is a battery flap into which said sound opening is integrated.

25. The ITE hearing device according to claim 24, wherein said recess is open in the direction of said battery flap.

26. The ITE hearing device according to claim 24, wherein said battery flap includes a protective element extending into said recess.

27. The ITE hearing device according to claim 26, wherein said protective element lies at least partially against wall regions of said side wall that bound said recess.

28. The ITE hearing device according to claim 27, wherein said protective element is in-set in said recess with a form-fit.

29. The ITE hearing device according to claim 26, wherein said protective element is a frame.
